(19) United States
(12) Patent Application Publication
(10) Pub. No.: US 2022/0044189 A1
(43) Pub. Date: Feb. 10, 2022

(54) CONTROL APPARATUS, NON-TRANSITORY COMPUTER READABLE MEDIUM, AND CONTROL METHOD

(71) Applicant: Toyota Jidosha Kabushiki Kaisha, Toyota-shi (JP)

(72) Inventors: Yusuke Nakade, Nagoya-shi (JP); Miho Otsuka, Nagoya-shi (JP); Shunsuke Tanimori, Nagoya-shi (JP); Hirokazu Kano, Nagoya-shi (JP); Scott R. Meyer, Allen, TX (US); Michael C. Edwards, McKinney, TX (US)

(21) Appl. No.: 17/393,684

(22) Filed: Aug. 4, 2021

(30) Foreign Application Priority Data
Aug. 6, 2020 (JP) 2020-134133

(51) Int. Cl. G06Q 10/08; B60W 30/06; B60W 60/00; B60W 50/14; G08G 1/14

(52) U.S. Cl. CPC G06Q 10/083; B60W 30/06; B60W 2552/00; B60W 50/14; G08G 1/141; B60W 60/001

(57) ABSTRACT

A control apparatus is communicably connected to a vehicle, the control apparatus including a controller configured to: upon receiving a use request for a delivery service of luggage using a trunk of the vehicle, identify a parking space that the vehicle is scheduled to park at; and determine whether a door of the trunk will be openable when the vehicle is in a parked state at the parking space.

### CROSS-REFERENCE TO RELATED APPLICATION

This application claims priority to Japanese Patent Application No. 2020-134133, filed on Aug. 6, 2020, the entire contents of which are incorporated herein by reference.

### TECHNICAL FIELD

The present disclosure relates to a control apparatus, a program, and a control method.

### BACKGROUND

Conventionally, automatic parking technology has been known for adjusting a target parking position based on a seating position of an occupant, in order to facilitate opening and closing of a door (see, for example, Patent Literature [PTL] 1).

### CITATION LIST

### Patent Literature

PTL 1: JP 2019-167028 A

### SUMMARY

PTL 1 considers a situation in which an occupant is on board when the vehicle is in a parked state, but fails to consider a situation in which a user of a trunk uses the trunk when the vehicle is in a parked state. Thus, the technology described in PTL 1 has room for improvement.

It would be helpful to provide a control apparatus, a program, and a control method, which are capable of supporting the use of a trunk when the vehicle is in a parked state.

A control apparatus according to an embodiment of the present disclosure is a control apparatus that is communicably connected to a vehicle, the control apparatus including a controller configured to:

upon receiving a use request for a delivery service of luggage using a trunk of the vehicle, identify a parking space that the vehicle is scheduled to park at; and

determine whether a door of the trunk will be openable when the vehicle is in a parked state at the parking space.

A program according to an embodiment of the present disclosure is configured to cause a computer as a control apparatus that is communicably connected to a vehicle, to execute operations, the operations including:

upon receiving a use request for a delivery service of luggage using a trunk of the vehicle, identifying a parking space that the vehicle is scheduled to park at; and

determining whether a door of the trunk will be openable when the vehicle is in a parked state at the parking space.

A control method according to an embodiment of the present disclosure is a control method by a control apparatus that is communicably connected to a vehicle, the control method including:

upon receiving a use request for a delivery service of luggage using a trunk of the vehicle; identifying a parking space that the vehicle is scheduled to park at; and

determining whether a door of the trunk will be openable when the vehicle is in a parked state at the parking space.

A control apparatus, a program, and a control method according to an embodiment of the present disclosure are capable of supporting the use of a trunk when the vehicle is in a parked state.

### BRIEF DESCRIPTION OF THE DRAWINGS

In the accompanying drawings:

FIG. 1 is a schematic diagram of an information processing system;

FIG. 2 is a block diagram illustrating a configuration of a vehicle;

FIG. 3 is a block diagram illustrating a configuration of a control apparatus;

FIG. 4 is a diagram illustrating a data structure for a request database (DB);

FIG. 5 is a diagram illustrating a parking space;

FIG. 6 is a diagram illustrating a vehicle in a parked state according to a first aspect;

FIG. 7 is a diagram illustrating a vehicle in a parked state according to a second aspect;

FIG. 8 is a diagram illustrating a vehicle in a parked state according to a third aspect; and

FIG. 9 is a flowchart illustrating operations of the control apparatus.

### DETAILED DESCRIPTION

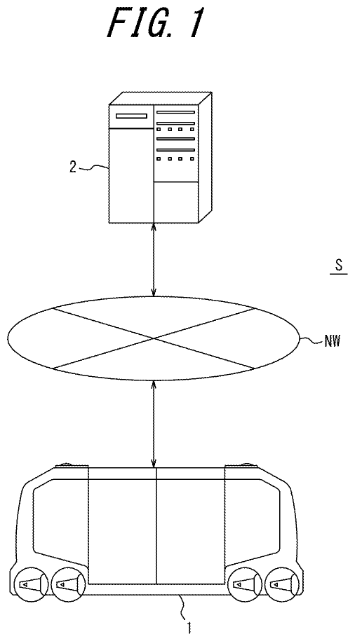

FIG. 1 is a schematic diagram of an information processing system S according to an embodiment of the present disclosure. The information processing system S includes a vehicle 1 and a control apparatus 2, which are communicably connected to each other via a network NW. FIG. 1 illustrates one each of the vehicle 1 and the control apparatus 2 for convenience of illustration. However, the number of the vehicle 1 and the number of the control apparatus 2 are not limited to one each. For example, the processing to be executed by the control apparatus 2 of the present embodiment may be executed by a plurality of distributed control apparatuses 2. The network NW includes, for example, a mobile communication network and the Internet.

An outline of processing to be executed by the control apparatus 2 according to the present embodiment will be described. The control apparatus 2, upon receiving a use request for a delivery service of luggage using a trunk of the vehicle 1, identifies a parking space that the vehicle is scheduled to park at; and determines whether a door of the trunk will be openable when the vehicle 1 is in a parked state at the parking space. This configuration enables the control apparatus 2 to take into consideration whether the door of the trunk will be openable when the vehicle 1 is in a parked state at the parking space, to thereby support the use of the trunk TR when the vehicle 1 is in a parked state.

The vehicle 1 includes, for example, any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. The driving of the vehicle 1 may be automated at any level. The level of automation is, for example, one of Level 1 to Level 5 in the level classification of the SAE. The name “SAE” is an abbreviation of Society of Automotive Engineers. The vehicle 1 may be a MaaS-dedicated vehicle. The term “MaaS” is an abbreviation of Mobility as a Service. Alternatively, the vehicle 1 may be driven by a driver.

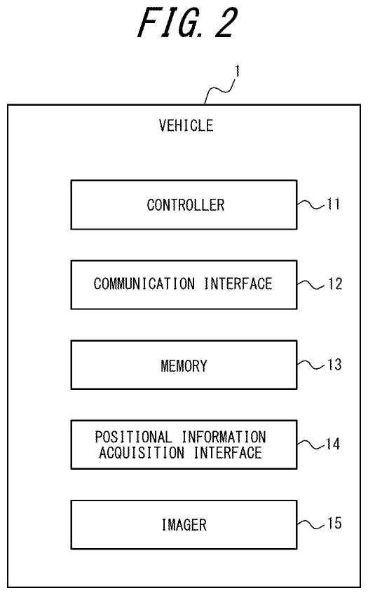

With reference to FIG. 2, an internal configuration of the vehicle 1 is described in detail.

The vehicle 1 includes a controller 11, a communication interface 12, a memory 13, a positional information acquisition interface 14, and an imager 15. The components of the vehicle 1 are communicably connected to one another via an in-vehicle network such as a Controller Area Network (CAN) or dedicated lines.

The controller 11 includes, for example, at least one general purpose processor including a Central Processing Unit (CPU) or a Micro Processing Unit (MPU). The controller 11 may include at least one dedicated processor that is dedicated to specific processing. The controller 11 may include at least one dedicated circuit instead of a processor. Examples of the dedicated circuit may include a Field-Programmable Gate Array (FPGA) and an Application Specific Integrated Circuit (ASIC). For example, the controller 11 may include an Electronic Control Unit (ECU).

The communication interface 12 includes at least one communication module for connecting to the network NW, the communication module being compliant with wired or wireless local area network (LAN) standard. The communication interface 12 may include at least one module compliant with a mobile communication standard such as the 4th Generation (4G) standard or the 5th Generation (5G) standard. The communication interface 12 may include at least one communication module or the like compliant with a short-range wireless communication standard or specification, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 is configured to transmit and receive any information via the network NW. This information includes positional information.

The memory 13 is, for example, a semiconductor memory, a magnetic memory, or an optical memory, but is not limited thereto. The memory 13 may function as, for example, a main memory, an auxiliary memory, or a cache memory. The memory 13 may store information resulting from analysis or processing performed by the controller 11. The memory 13 may store various types of information or the like related to the operations or control of the vehicle 1. The memory 13 may store a system program, an application program, embedded software, or the like.

The positional information acquisition interface 14 includes at least one GNSS receiver. The term “GNSS” is an abbreviation of global navigation satellite system. Examples of GNSS include GPS, QZSS, BeiDou, GLONASS, and Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positional information acquisition interface 14 measures the position of the vehicle 1.

The imager 15 includes a camera and can capture an image of surroundings. For analysis, the imager 15 may record the captured image in the memory 13, transmit the captured image to the controller 11, or transmit the captured image to the control apparatus 2.

The control apparatus 2 may be a server configured to assist a vehicle dispatch service provider in providing the service. The control apparatus 2 may be, for example, installed in a facility dedicated to a vehicle dispatch provider or in a shared facility including a data center. The control apparatus 2 can control operations of the vehicle 1. Alternatively, the control apparatus 2 may be mounted in the vehicle 1.

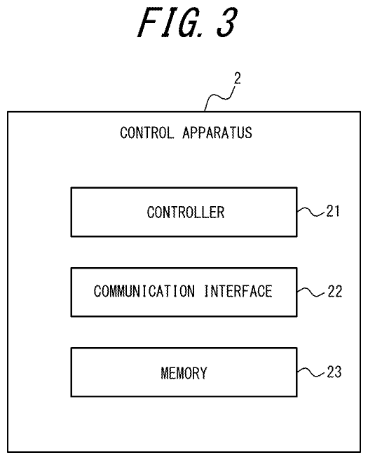

With reference to FIG. 3, an internal configuration of the control apparatus 2 will be described in detail.

The control apparatus 2 includes a controller 21, a communication interface 22, and a memory 23. The components of the control apparatus 2 are communicably connected to one another via, for example, dedicated lines.

The hardware configurations of the controller 21, the communication interface 22, and the memory 23 of the control apparatus 2 of the present embodiment may be the same as the hardware configurations of the controller 11, the communication interface 12, and the memory 13 of the vehicle 1. Therefore, a description thereof is omitted here.

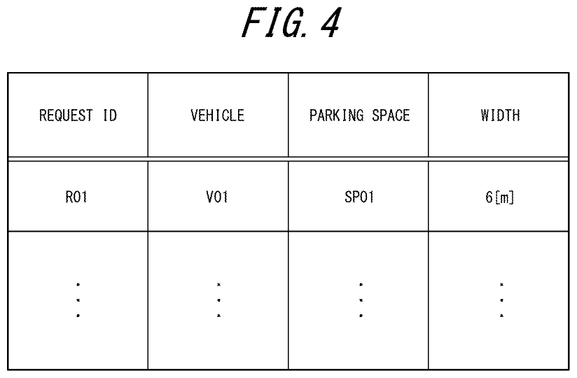

The memory 23 includes the request DB illustrated in FIG. 4. In the request DB, an identifier for a vehicle to be parked (corresponding to the “VEHICLE” of FIG. 4), an identifier for a parking space at which a vehicle is to be parked (corresponding to the “PARKING SPACE” of FIG. 4), and a longitudinal width of the parking space (corresponding to the “WIDTH” of FIG. 4) are stored in association with the request ID as an identifier. Alternatively, the request DB may be stored in a storage device external to the control apparatus 2 and accessed by the control apparatus 2.

Hereinafter, processing to be executed in the information processing system S according to the present embodiment will be described in detail. A situation will be described herein, by way of example, in which a user of the vehicle 1 uses an application or other communication services to use a delivery service of luggage using a trunk of the vehicle 1.

The delivery service of luggage in the present embodiment is a service in which a delivery person delivers luggage addressed to a user, to the trunk of the vehicle 1 of the user. Alternatively, the delivery service of luggage may be a service in which a user of the vehicle 1 stores luggage addressed to another user in the trunk of the vehicle 1, so that a delivery person can take over the luggage and deliver the luggage.

A user of the vehicle 1 operates a terminal of the user to transmit, to the control apparatus 2, a use request for the delivery service of luggage. The use request includes the vehicle 1 (herein referred to as “V01”) of the user, and a parking space (herein referred to as “SP01”) that the vehicle 1 is scheduled to park at. Upon receiving the use request, the control apparatus 2 stores the information included in the use request in the request DB as illustrated in FIG. 4.

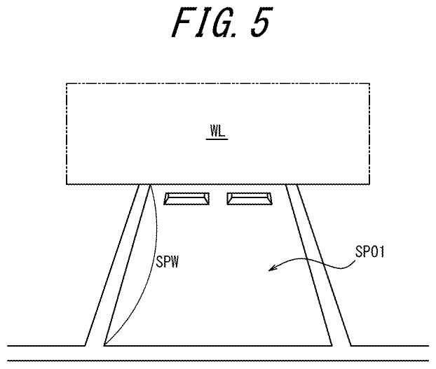

The control apparatus 2 controls the vehicle 1 to move the vehicle to the parking space SP01 of FIG. 5. By way of example, the parking space SP01 of the present embodiment has a wall WL in the back thereof. Thus, when the vehicle 1 is to reverse park by moving backward, the vehicle 1 needs to be parked while ensuring a sufficient width left between the wall WL and the vehicle 1 so that a delivery person can open and close the door of the trunk of the vehicle 1.

The control apparatus 2 uses the imager 15 of the vehicle 1 to capture an image of the parking space SP01. The control apparatus 2 analyzes the captured image and calculates the longitudinal width SPW of the parking space SP01. The control apparatus 2 stores the calculated width SPW in the request DB in association with the request ID as illustrated in FIG. 4. Alternatively, the control apparatus 2 may acquire information on the longitudinal width of the parking space SP01 from the memory 23 or any storage device, and store the information in the request DB in association with the request IDs as illustrated in FIG. 4.

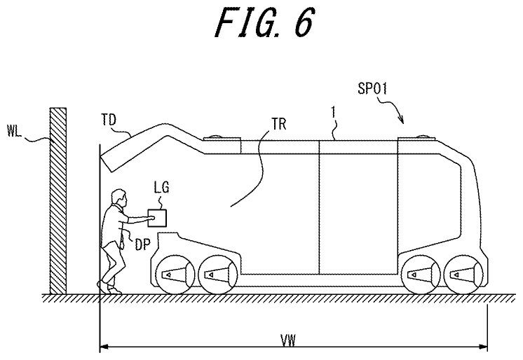

The control apparatus 2 acquires, from the memory 23 or any storage device, information on the total longitudinal length VW (see FIG. 6) of the vehicle 1 in a state in which a door TD of the trunk TR of the vehicle 1 is opened. The control apparatus 2 determines whether Inequality A below is satisfied.

(Longitudinal Width of Parking Space SP01)≥(Total Longitudinal Length VW of Vehicle 1 with Door TD of Trunk TR of Vehicle 1 opened)+(Arbitrary Margin Width) [Inequality A]:

When determined that Inequality A is satisfied, the control apparatus 2 controls the vehicle 1 to park at the parking space SP01 while leaving a width necessary for opening and closing the door TD (the width corresponding to the “margin width” in Inequality A). At this time, the control apparatus 2 may control the vehicle 1 to park through automatic parking control, or may give a notification to the driver of the vehicle 1 to park the vehicle 1 backward while leaving a width necessary for opening and closing the door TD. The control apparatus 2 may give the notification to the driver of the vehicle 1 via a speaker of the vehicle 1 or via a speaker of a terminal possessed by the driver of the vehicle 1. The control apparatus 2 may give the notification to the driver of the vehicle 1 when the vehicle 1 is in the vicinity of the parking space SP01 (e.g., within a predetermined distance from the parking space SP01) and the vehicle 1 is traveling at a low speed (e.g., at a speed of less than a predetermined value). The presence of the vehicle 1 in the vicinity of the parking space SP01 can be determined based on the positional information acquired by the positional information acquisition interface 14.

As illustrated in FIG. 6, a sufficient width is ensured between the wall WL and the vehicle 1. The delivery person DP can open the door TD to deliver the luggage LG to the trunk TR.

When determined that Inequality A is not satisfied, the control apparatus 2 may determine whether the vehicle 1 is allowed to park forward by heading toward the wall WL to park at the parking space SP01. In particular, the control apparatus 2 may access the memory 23 or any storage device to search for any law or agreement made by the owner or operator of the parking space SP01 that allows vehicles to park forward into the parking space SP01.

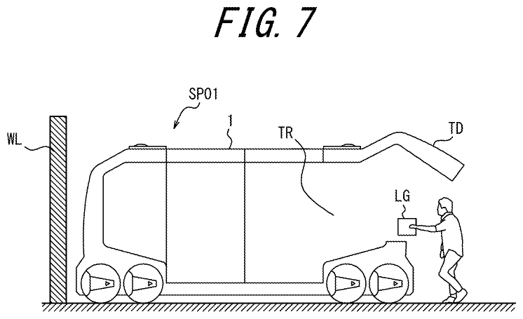

When determined that the vehicle 1 is allowed to park forward, the control apparatus 2 controls the vehicle 1 to park forward as illustrated in FIG. 7. At this time, the control apparatus 2 may control the vehicle 1 to park forward through automatic parking control, or may give a notification to the driver of the vehicle 1 to park the vehicle 1 forward. The delivery person DP does not have to enter between the vehicle 1 and the wall WL. Thus, only a small width is needed between the vehicle 1 and the wall WL. The delivery person DP opens the door TD of the trunk TR of the parked vehicle 1 and delivers the luggage LG to the trunk TR.

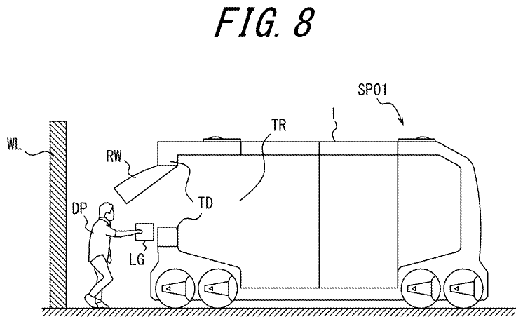

When determined that Inequality A is not satisfied, the control apparatus 2 determines whether a rear window RW of the vehicle 1 will be openable when the vehicle 1 is in a parked state at the parking space SP01 as illustrated in FIG. 8. Specifically, the control apparatus 2 acquires, from the memory 23 or any storage device, information on the total longitudinal length of the vehicle 1 in a state in which the rear window RW of the vehicle 1 is opened. The control apparatus 2 determines whether Inequality B below is established.

(Longitudinal Width of Parking Space SP01)≥(Total Longitudinal Length of Vehicle 1 with Rear Window RW of Vehicle 1 opened)+(Arbitrary Margin Width) [Inequality B]:

When determined that Inequality B is satisfied, the control apparatus 2 controls the vehicle 1 to park backward into the parking space SP01 in a state in which the opening of the door TD is prohibited and the opening of the rear window RW is permitted. At this time, the control apparatus 2 may control the vehicle 1 to park through automatic parking control, or may give a notification to the driver of the vehicle 1 to park the vehicle 1 backward in a state in which the opening of the door TD is prohibited and the opening of the rear window RW is permitted. In this manner, as illustrated in FIG. 8, the delivery person DP can enter between the wall WL and the vehicle 1, open the rear window RW, and deliver the luggage LG to the trunk TR.

When determined that Inequality B is not satisfied, the control apparatus 2 may give a notification to a terminal of the user that the delivery service of luggage cannot be received at the parking space SP01.

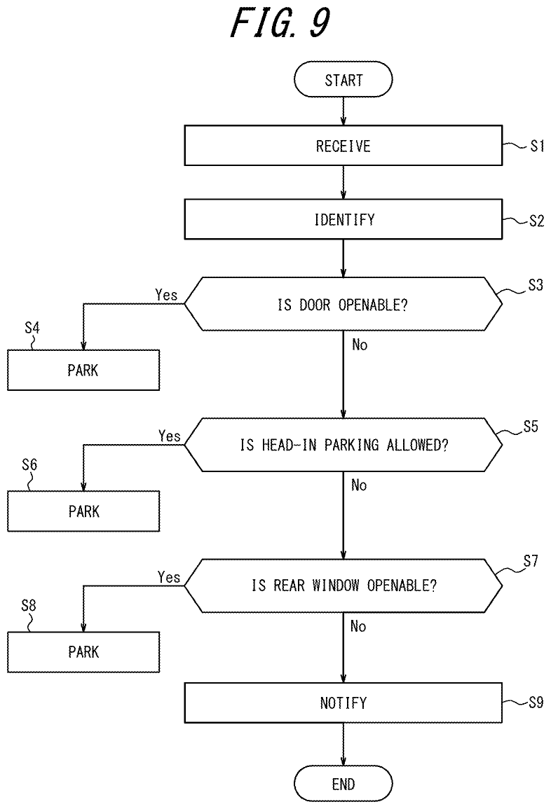

With reference to FIG. 9, a control method by the control apparatus 2 will be described.

In Step S1, the control apparatus 2 receives a use request for a delivery service of luggage using the trunk TR of the vehicle 1.

In Step S2, the control apparatus 2 identifies the parking space SP01 that the vehicle 1 is scheduled to park at.

In Step S3, the control apparatus 2 determines whether the door TD of the trunk TR will be openable when the vehicle 1 is in a parked state at the parking space SP01.

When YES in Step S3, the control apparatus 2 controls, in Step S4, the vehicle 1 to park at the parking space SP01 while leaving a width necessary for opening the door TD.

When NO in Step S3, the control apparatus 2 determines, in Step S5, whether the vehicle 1 is allowed to park forward by heading into the parking space SP01.

When YES in Step S5, the control apparatus 2 controls the vehicle 1 to park forward in Step S6.

When NO in Step S5, the control apparatus 2 determines, in Step S7, whether the rear window RW of the vehicle 1 will be openable when the vehicle is in a reverse-parked state at the parking space SP01.

When YES in Step S7, the control apparatus 2 controls, in Step S8, the vehicle 1 to reverse park in a state in which opening of the door TD is prohibited and opening of the rear window RW is permitted.

When NO in Step S7, the control apparatus 2 gives, in Step S9, a notification to a terminal of the user that the delivery service of luggage cannot be received at the parking space SP01.

Alternatively, the control apparatus 2 may execute Step S5 and Step S7 interchangeably. Further alternatively, the control apparatus 2 may execute only one of Step S5 and Step S7.

As described above, according to the present embodiment, a controller 21 of a control apparatus 2, upon receiving a use request for a delivery service of luggage LG using a trunk TR of a vehicle 1, identifies a parking space SP01 that the vehicle 1 is scheduled to park at, and determines whether a door TD will be openable when the vehicle 1 is in a parked state at the parking space SP01. This configuration enables the control apparatus 2 to give consideration to the opening and closing of the door TD of the trunk TR when the trunk TR is used, to thereby support the use of the trunk TR when the vehicle 1 is in a parked state.

According to the present embodiment, the controller 21 determines whether the door TD will be openable, based on the longitudinal width of the parking space SP01 and the total longitudinal length of the vehicle 1 in a state in which the door TD is opened. This configuration enables the control apparatus 2 to reliably ensure an appropriate width for opening and closing the door TD.

According to the present embodiment, when determined that the door TD will be openable, the controller 21 controls the vehicle 1 to park at the parking space SP01 while leaving a width necessary for opening the door TD. This configuration enables the control apparatus 2 to ensure a sufficient width for opening and closing the door TD.

According to the present embodiment, when determined that the door TD will not be openable, the controller 21 determines whether the vehicle 1 is allowed to park forward by heading into the parking space SP01, and when determined that the vehicle 1 is allowed to park forward, the controller 21 controls the vehicle 1 to park forward by heading into the parking space SP01. This configuration enables the control apparatus 2 to control the vehicle 1 to park forward in a case in which the door TD will not be openable when the vehicle 1 is reverse parked, so that the door TD can be opened, to thereby support the use of the trunk TR.

According to the present embodiment, when determined that the door TD will not be openable, the controller 21 determines whether the rear window RW of the vehicle 1 will be openable when the vehicle 1 is in a parked state at the parking space SP01. When determined that the rear window RW will be openable, the controller 21 controls the vehicle 1 to park at the parking space SP01 while leaving a width necessary for opening the rear window RW in a state in which opening of the door TD is prohibited and opening of the rear window RW is permitted. This configuration enables, even in a case in which the door TD will not be openable, the control apparatus 2 to control the vehicle 1 to park as long as the rear window RW will be openable, to thereby enable the use of a delivery service of the luggage LG. At this time, the opening of the door TD is prohibited and the opening of the rear window RW is permitted, which can reduce damage to the door TD and other property damage to other objects, which may otherwise be caused by the opening of the door TD.

According to the present embodiment, the controlling of the vehicle 1 to park at the parking space SP01 includes at least one of: controlling the vehicle 1 to perform automatic parking control for parking at the parking space SP01; and giving a notification to the driver of the vehicle 1 to park the vehicle 1 at the parking space SP01. This configuration enables the control apparatus 2 to reliably control the vehicle 1 to park, regardless of whether the vehicle 1 is provided with an automatic parking function.

According to the present embodiment, the control apparatus 2 gives the notification when the vehicle 1 is present in the vicinity of the parking space SP01 and the speed of the vehicle 1 is less than a predetermined value. This configuration enables the control apparatus 2 to give the notification only in a case in which the vehicle 1 is trying to park at the parking space SP01, which can reduce the trouble of erroneously giving the notification in other cases.

While the present disclosure has been described with reference to the drawings and examples, it should be noted that various modifications and revisions can be implemented by those skilled in the art based on the present disclosure. Other modifications can be made without departing from the spirit of the present disclosure. For example, functions or the like included in each step can be rearranged without logical inconsistency, and a plurality of steps can be combined into one or divided.

For example, in the aforementioned embodiment, a program configured to execute all or some of the functions or processing of the control apparatus 2 can be recorded on a computer readable recording medium. The computer readable recording medium includes a non-transitory computer readable medium, and may be a magnetic recording device, an optical disc, a magneto-optical recording medium, or a semiconductor memory. The distribution of the program is performed by, for example, sale, transfer, or rental of a portable recording medium such as a Digital Versatile Disc (DVD) or a Compact Disc Read Only Memory (CD-ROM) on which the program is recorded. The program may also be distributed by storing the program in a storage of any server and transmitting the program from the server to another computer. The program may also be provided as a program product. The present disclosure can also be realized as a program that can be executed by a processor.

1. A control apparatus that is communicably connected to a vehicle, the control apparatus comprising a controller configured to:
upon receiving a use request for a delivery service of luggage using a trunk of the vehicle, identify a parking space that the vehicle is scheduled to park at; and
determine whether a door of the trunk will be openable when the vehicle is in a parked state at the parking space.

2. The control apparatus according to claim 1, wherein the controller is configured to determine whether the door will be openable, based on a longitudinal width of the parking space and a total longitudinal length of the vehicle in a state in which the door of the trunk is opened.

3. The control apparatus according to claim 1, wherein, when determined that the door will be openable, the controller is configured to control the vehicle to park at the parking space while leaving a width necessary for opening the door.

4. The control apparatus according to claim 1, wherein,
when determined that the door will not be openable, the controller is configured to determine whether the vehicle is allowed to park forward by heading into the parking space, and
when determined that the vehicle is allowed to park forward, the controller is configured to control the vehicle to park forward by heading into the parking space.

5. The control apparatus according to claim 1, wherein,
when determined that the door will not be openable, the controller is configured to determine whether a rear window of the vehicle will be openable when the vehicle is in a parked state at the parking space, and
when determined that the rear window will be openable, the controller is configured to control the vehicle to park at the parking space while leaving a width necessary for opening the rear window in a state in which opening of the door is prohibited and opening of the rear window is permitted.

6. The control apparatus according to claim 3, wherein the controller is configured to control the vehicle to park at the parking space by:
controlling the vehicle to perform automatic parking control for parking at the parking space; and/or
giving a notification to a driver of the vehicle to park the vehicle at the parking space.

7. The control apparatus according to claim 6, wherein the controller is configured to give the notification when the vehicle is in a vicinity of the parking space and a speed of the vehicle is less than a predetermined value.

8. A vehicle having the control apparatus according to claim 1 mounted therein.

9. A non-transitory computer readable medium storing a program configured to cause a computer as a control apparatus that is communicably connected to a vehicle, to execute operations, the operations comprising:
upon receiving a use request for a delivery service of luggage using a trunk of the vehicle, identifying a parking space that the vehicle is scheduled to park at; and
determining whether a door of the trunk will be openable when the vehicle is in a parked state at the parking space.

10. The non-transitory computer readable medium according to claim 9, wherein the determining of whether the door will be openable includes determining based on a longitudinal width of the parking space and a total longitudinal length of the vehicle in a state in which the door of the trunk is opened.

11. The non-transitory computer readable medium according to claim 9, wherein the operations further comprise controlling, when determined that the door will be openable, the vehicle to park at the parking space while leaving a width necessary for opening the door.

12. The non-transitory computer readable medium according to claim 9, wherein the operations further comprise:
determining, when determined that the door will not be openable, whether the vehicle is allowed to park forward by heading into the parking space; and
controlling, when determined that the vehicle is allowed to park forward, the vehicle to park forward by heading into the parking space.

13. The non-transitory computer readable medium according to claim 9, wherein the operations further comprise:
determining, when determined that the door will not be openable, whether a rear window of the vehicle will be openable when the vehicle is in a parked state at the parking space; and
controlling, when determined that the rear window will be openable, the vehicle to park at the parking space while leaving a width necessary for opening the rear window in a state in which opening of the door is prohibited and opening of the rear window is permitted.

14. The non-transitory computer readable medium according to claim 11, wherein the controlling of the vehicle to park at the parking space includes at least one of:
controlling the vehicle to perform automatic parking control for parking at the parking space; and
giving a notification to a driver of the vehicle to park the vehicle at the parking space.

15. A control method by a control apparatus that is communicably connected to a vehicle, the control method comprising:
upon receiving a use request for a delivery service of luggage using a trunk of the vehicle, identifying a parking space that the vehicle is scheduled to park at; and
determining whether a door of the trunk will be openable when the vehicle is in a parked state at the parking space.

16. The control method according to claim 15, wherein the determining of whether the door will be openable includes determining whether the door will be openable based on a longitudinal width of the parking space and a total longitudinal length of the vehicle in a state in which the door of the trunk is opened.

17. The control method according to claim 15, comprising controlling, when determined that the door will be openable, the vehicle to park at the parking space while leaving a width necessary for opening the door.

18. The control method according to claim 15, comprising:
when determined that the door will not be openable, determining whether the vehicle is allowed to park forward by heading into the parking space; and
when determined that the vehicle is allowed to park forward, controlling the vehicle to park forward by heading into the parking space.

19. The control method according to claim 15, comprising:
when determined that the door will not be openable, determining whether a rear window of the vehicle will be openable when the vehicle is in a parked state at the parking space; and
when determined that the rear window will be openable, controlling the vehicle to park at the parking space while leaving a width necessary for opening the rear window in a state in which opening of the door is prohibited and opening of the rear window is permitted.

20. The control method according to claim 17, wherein the controlling of the vehicle to park at the parking space includes at least one of:
controlling the vehicle to perform automatic parking control for parking at the parking space; and
giving a notification to a driver of the vehicle to park the vehicle at the parking space.
